(19) United States
(12) Patent Application Publication
(10) Pub. No.: US 2020/0016544 A1
(43) Pub. Date: Jan. 16, 2020

(54) METHOD FOR WASHING HOLLOW FIBER MEMBRANE MODULE AND HOLLOW FIBER MEMBRANE FILTRATION DEVICE

(71) Applicant: KURITA WATER INDUSTRIES LTD., Tokyo (JP)

(72) Inventor: Keijirou TADA, Tokyo (JP)

(21) Appl. No.: 16/497,476

(22) PCT Filed: Sep. 15, 2017
(86) PCT No.: PCT/JP2017/033549

§ 371 Date: Sep. 25, 2019

(30) Foreign Application Priority Data
Mar. 29, 2017 (JP) 2017-065529

(51) Int. Cl. B01D 65/06; B01D 29/78; C02F 1/44

(52) U.S. Cl. CPC B01D 65/06; B01D 63/02; C02F 1/44; B01D 29/78

(57) ABSTRACT

A hollow fiber membrane filtration device includes a hollow fiber membrane module including a vessel that includes a treated water outlet and a concentrated water outlet, hollow fiber membranes, an upper end fixing member that fixes upper end parts of the hollow fiber membranes, a permeated water chamber that is formed on an upper side of the upper end fixing member, a water conduit through which raw water is supplied into the vessel, and a diffusion tube that is provided on a lower side of the hollow fiber membranes. A plurality of ejection holes are provided on a side peripheral surface of the water conduit. A raw water pipe and gas introduction device are connected with the water conduit. A drainage port is provided at a lower part of the vessel.

### TECHNICAL FIELD

The present invention relates to a method for washing a hollow fiber membrane module and a hollow fiber membrane filtration device, and particularly, relates to a method for washing a hollow fiber membrane module and a hollow fiber membrane filtration device that make it possible to sufficiently remove, by wash, suspended matter attached to a membrane.

### BACKGROUND ART

In fields such as pure water production and water recovery, a hollow fiber membrane module has been widely used as means for removing suspended matter components and organic matters. As a membrane of the hollow fiber membrane module, a microfiltration membrane (MF membrane), an ultrafiltration membrane (UF membrane) or the like is selectively used depending on separation objects. Generally, the former has a pore of around 0.1 μm, and the latter has a pore of 0.005 to 0.5 μm.

When large amounts of suspended matter and organic matter are contained in suspension that is supplied to the hollow fiber membrane module, the clogging of the membrane occurs, resulting in not only the increase in backwash frequency and chemical wash frequency but also the increase in membrane replacement frequency. For preventing the clogging of the membrane, a method involving decreasing the flow volume per unit area of the membrane is generally adopted, but this method has a problem of the increase in the number of membranes to be provided.

For reducing the pollution of the membrane, there is known a method involving performing a flocculation treatment step at a stage prior to the hollow fiber membrane module. However, the increase in suspended matter amount due to a flocculation agent causes the suspended matter pollution of the membrane. In such a situation, it is strongly demanded to establish a membrane module structure and backwash method for increasing the suspended matter removal performance of the membrane.

In Patent Literature 1, there is proposed a backwash method involving using air and water for enhancing the suspended matter removal performance of the membrane. However, in some cases, this method does not greatly enhance the suspended matter removal performance, depending on the kind and amount of the suspended matter, and a higher-performance backwash method is demanded.

In general air washes, air flows from a lower part of the membrane module to an upper part. However, since there is a vertical difference in the strength of the air, the air does not go through the whole of the membrane module, and some spots are insufficiently washed. Further, when the drainage is performed at a lower part at the time of the air wash, the air is drained without penetrating the interior of the membrane module. Therefore, the drainage can be performed only at an upper part of the module, for example, at a circulation part. Accordingly, in some cases, the suspended matter peeled off from the whole of the membrane module by the air wash is attached to the upper part of the membrane.

In the case of a hollow fiber membrane in which only an upper end is fixed, there is a concern that a strong air wash causes kinking or folding of the hollow fiber membrane at a lower part of the membrane module.

### CITATION LIST

### Patent Literature

PTL1: JP 2005-88008 A

PTL2: JPH 5-96136 A

PTL3: JP 2002-204930 A

### SUMMARY OF INVENTION

The present invention has been made in view of the above conventional circumstance, and has an object to provide a method for washing a hollow fiber membrane module and a hollow fiber membrane filtration device that make it possible to remove the suspended matter attached to the hollow fiber membrane evenly and sufficiently.

A method for washing a hollow fiber membrane module in the present invention is a method for washing a hollow fiber membrane module, the hollow fiber membrane module comprising: a vessel that comprises a treated water outlet and a concentrated water outlet; a water conduit through which raw water is supplied into the vessel; a plurality of hollow fiber membranes each of which separates the raw water into permeated water and concentrated water, each of the hollow fiber membranes being vertically disposed in the vessel; an upper end fixing member that fixes upper end parts of the hollow fiber membranes, the upper end fixing member being disposed at an upper part in the vessel; a treated water chamber that is formed on an upper side of the upper end fixing member, the treated water chamber communicating with an interior of each of the hollow fiber membranes; and a diffusion member that is disposed on a lower side of the hollow fiber membranes, wherein the water conduit vertically extends on a lower side of the upper end fixing member, and a plurality of ejection holes are provided on a side peripheral surface, each of the ejection holes being a hole through which the raw water is ejected, and a drainage port is provided at a lower part of the vessel, the drainage port being a drainage port through which wash drainage water is drained, wherein the method for washing the hollow fiber membrane module, comprises performing a bubbling wash in which gas is injected from the diffusion member, and a water backwash in which backwash water is supplied from the treated water outlet into the hollow fiber membranes.

In an aspect of the present invention, the water backwash is performed at a time after or at the same time when air or the air and the raw water are supplied from the water conduit.

In an aspect of the present invention, drainage from the drainage port is performed at a time after the air or the air and the raw water are supplied from the water conduit or at a time after the water backwash is performed.

In an aspect of the present invention, after the bubbling wash, the water backwash is performed at a time after or at the same time when air or the air and the raw water are supplied from the water conduit.

In an aspect of the present invention, a chemical is added to the backwash water.

In an aspect of the present invention, the hollow fiber membranes are fixed by only the upper end fixing member.

In an aspect of the present invention, the water conduit is provided so as to penetrate a bottom portion of the vessel and extend in the vessel, and the plurality of ejection holes are provided on the water conduit.

A hollow fiber membrane filtration device in the present invention comprises a hollow fiber membrane module, the hollow fiber membrane module comprising: a vessel that comprises a treated water outlet and a concentrated water outlet; a water conduit through which raw water is supplied into the vessel; a plurality of hollow fiber membranes each of which separates the raw water into permeated water and concentrated water, each of the hollow fiber membranes being vertically disposed in the vessel; an upper end fixing member that fixes upper end parts of the hollow fiber membranes, the upper end fixing member being disposed at an upper part in the vessel; a treated water chamber that is formed on an upper side of the upper end fixing member, the treated water chamber communicating with an interior of each of the hollow fiber membranes; and a diffusion member that is disposed on a lower side of the hollow fiber membranes, wherein the water conduit vertically extends on a lower side of the upper end fixing member, and a plurality of ejection holes are provided on a side peripheral surface, each of the ejection holes being a hole through which the raw water is ejected, a drainage port is provided at a lower part of the vessel, the drainage port being a drainage port through which wash drainage water is drained, and a raw water pipe and gas introduction means are connected with the water conduit.

### Advantageous Effects of Invention

In the hollow fiber membrane filtration device according to the present invention, the bubbling wash is performed by injecting the gas from the diffusion member provided on the lower side of the hollow fiber membranes, and therefore, it is possible to make the air go through the whole of the membrane module, and to remove the suspended matter attached to the hollow fiber membrane evenly and sufficiently.

### BRIEF DESCRIPTION OF DRAWINGS

FIG. 1 is a schematic diagram of a hollow fiber membrane filtration device according to an embodiment.

FIG. 2 is a schematic diagram of the hollow fiber membrane filtration device at the time of a wash treatment.

FIG. 3 is a schematic diagram of the hollow fiber membrane filtration device at the time of a wash treatment.

FIG. 4 is a schematic diagram of the hollow fiber membrane filtration device at the time of a wash treatment.

FIG. 5 is a schematic diagram of the hollow fiber membrane filtration device at the time of a wash treatment.

FIG. 6 is a schematic diagram of the hollow fiber membrane filtration device at the time of a wash treatment.

FIG. 7 is a schematic diagram of the hollow fiber membrane filtration device at the time of a wash treatment.

FIG. 8 is a schematic diagram of the hollow fiber membrane filtration device at the time of a wash treatment.

FIG. 9 is a schematic diagram of a drainage port provided at a bottom part of a vessel.

### DESCRIPTION OF EMBODIMENTS

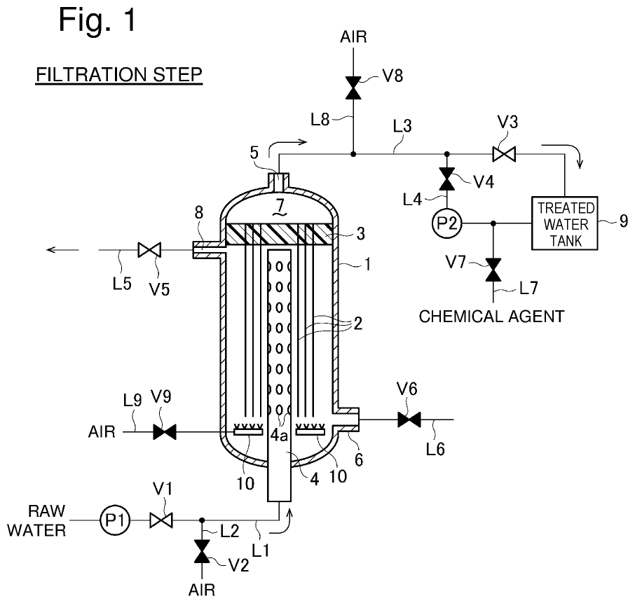

An embodiment will be described below with reference to FIG. 1 to FIG. 4.

FIG. 1 is a schematic diagram showing the filtration step of a hollow fiber membrane filtration device comprising a hollow fiber membrane module according to the embodiment. As shown in FIG. 1, the hollow fiber membrane module comprises a vessel 1 disposed such that an axis line direction of a cylinder is a vertical direction (a perpendicular direction in the embodiment). In the vessel 1, a plurality of hollow fiber membranes 2 are disposed.

The hollow fiber membranes 2 are fixed by a potting member 3 as a fixing member, which is made of a synthetic resin, at an upper side of the vessel 1, and is not fixed at a lower side of the vessel 1. For example, an epoxy resin can be used as the synthetic resin of the potting member 3.

For example, the hollow fiber membranes 2 are put in a U-shape, and both ends of the hollow fiber membrane are fixed by the potting member 3. In this case, an intermediate part of each of the hollow fiber membranes 2 is positioned at a lower part of the vessel 1.

Further, in the case of hollow fiber membranes 2 in which one end is opened and the other end is sealed, the opened one end side of the hollow fiber membranes 2 is fixed by the potting member 3, and the sealed other end side is disposed at a lower part of the vessel 1.

The hollow fiber membranes 2 may be any of a UF membrane, an MF membrane and the like. The hollow fiber membranes 2 are not particularly limited, and typically, hollow fiber membranes 2 having an inner diameter of about 0.2 to 1.0 mm, an outer diameter of about 0.5 to 2.0 mm and an effective length of about 300 to 2500 mm is used. Preferably, such hollow fiber membranes 2, the number of which is 500 to 70000, should be loaded in the vessel 1, such that the total membrane area is about 5 to 100 m². The membrane material of the hollow fiber membranes 2 is not particularly limited, and PVDF (polyvinylidene fluoride), polyethylene, polypropylene or the like can be used. In the embodiment, the hollow fiber membrane module comprising the hollow fiber membranes 2 will be described, but it is only necessary to be a membrane module using a tubular membrane.

A treated water chamber 7 is compartmentally formed on an upper side of the potting member 3. An upper end side of the hollow fiber membranes 2 penetrates the potting member 3, the opening of the upper end faces the treated water chamber 7, and the interior of the hollow fiber membranes 2 communicates with the treated water chamber 7. In the case where the hollow fiber membranes 2 are put in a U-shape, both ends of the hollow fiber membranes 2 penetrate the potting member 3.

The potting member 3 has a disk shape, for example, and the outer peripheral surface or outer edge part contacts with the inner surface of the vessel 1 in a watertight manner.

At a lower part in the vessel 1, a diffusion tube 10 as a diffusion member is provided under the hollow fiber membranes 2. One end of a pipe L9 including a valve V9 is connected with the diffusion tube 10. The other end of the pipe L9 is connected with an air pressure source (not illustrated) including an air pump.

In the interior of the vessel 1, a water conduit 4 extends in a roughly vertical direction (an axial direction of the vessel 1). For example, the water conduit 4 is disposed along the central axis of the vessel 1. The water conduit 4 is a circular pipe in which a distal end (upper end) is closed, and on the side peripheral surface, a plurality of ejection holes 4a are wholly provided at intervals in the vertical direction and the circumferential direction. The number of the ejection holes 4a is not particularly limited, and for example, is about 5 to 50.

The height (the length in the vertical direction) of the water conduit 4 is not particularly limited. It is preferable that the upper end of the water conduit 4 is positioned near a lower surface of the potting member 3. The size and shape of the ejection hole 4a are not particularly limited. For example, a circular shape having a diameter of 5 to 50 mm is adopted. The inner diameter of the water conduit 4 is about 10 to 100 mm, for example. Further, the upper end of the water conduit may be buried in the potting member 3.

A lower part of the water conduit 4 is provided so as to penetrate a bottom portion of the vessel 1 and extends to the exterior of the vessel 1. A raw water pipe L1 is connected with the water conduit 4, and a pump P1 and a valve V1 are provided on the raw water pipe L1. One end of an air introduction pipe L2 is connected with the raw water pipe L1, and a valve V2 is provided on the air introduction pipe L2. The other end of the pipe L2 is connected with an air pressure source (not illustrated) including an air pump.

The opening and closing of the valve V1 and the valve V2 are switched, and thereby, the supply of the raw water/air to the vessel 1 can be switched. The valve V1 is opened and the valve V2 is closed, so that the raw water is fed through the raw water pipe L1 by the pump P1. Thereby, it is possible to eject the raw water from the ejection holes 4a on the water conduit 4 in a radial direction, and to supply the raw water into the vessel 1.

The valve V1 is closed and the valve V2 is opened, so that the air is supplied from the air introduction pipe L2. Thereby, it is possible to eject bubbles from the ejection holes 4a of the water conduit 4 in the radial direction, and to perform a bubbling wash. The valves V1, V2 are opened, and thereby, it is possible to eject gas-liquid mixture from the ejection holes 4a.

An outlet 5 for treated water (filtered water) is provided at a top part of the vessel 1. Further, a concentrated water outlet 8 is provided at an upper part of the side surface of the vessel 1. The concentrated water outlet 8 is provided near the lower surface of the potting member 3. It is preferable that the distance from the potting member 3 to an upper edge of the concentrated water outlet 8 be about 0 to 30 mm, particularly, about 0 to 10 mm. A pipe L5 is connected with the concentrated water outlet 8, and a valve V5 is provided on the pipe L5.

A drainage port 6 is provided at a lower part of the side surface of the vessel 1. The drainage port 6 is provided near the bottom portion of the vessel 1. A pipe L6 is connected with the drainage port 6, and a valve V6 is provided on the pipe L6.

A treated water removing pipe L3 is connected with the treated water outlet 5, and the treated water (filtered water) is drained through the treated water removing pipe L3. The treated water is stored in a treated water tank 9.

With the treated water removing pipe L3, one end of a backwash water pipe L4 is connected at a position between a valve V3 provided on the treated water removing pipe L3 and the treated water outlet 5. The other end side of the backwash water pipe L4 is connected with the treated water tank 9 through a valve V4 and a pump P2. The valve V3 is closed, the valve V4 is opened, and the pump P2 is actuated, so that filtered water flows from the treated water outlet 5 to the vessel 1 through the backwash water pipe L4. Thereby, it is possible to perform the backwash of the hollow fiber membranes 2. FIG. 1 shows a configuration in which the backwash water pipe L4 is connected with the treated water tank 9 and the filtered water is used as the backwash water, but the backwash water may be the raw water.

Chemical adding means (not illustrated) including a pipe L7 and a valve V7 is connected with the upstream side of the pump P2 of the backwash water pipe L4, such that a chemical is added to the backwash water that flows through the backwash water pipe L4. The chemical to be added is sodium hypochlorite, a strong alkaline agent, a strong acid agent, or the like, and is selected depending on the membrane-attached matter. For example, in the case where the membrane-attached matter is an organic matter, a suspended matter containing an organic matter or the like, it is preferable that sodium hypochlorite be added so as to remain at 0.05 to 0.3 mgCl₂/L.

One end of a pipe L8 including a valve V8 is connected with the pipe L3, such that the air is supplied to the pipe L3 between the valve V3 and the treated water outlet 5. At the other end of the pipe L8, a switching valve (not illustrated) for switching between the connection with an air pressure source (not illustrated) including an air pump and the like and the opening to the atmosphere is provided.

[Filtration Treatment]

In a filtration treatment by the hollow fiber membrane filtration device, as shown in FIG. 1, the valves V1, V3, V5 are opened, the valves V2, V4, V6, V7, V8, V9 are closed, the pump P1 is actuated, and the raw water is supplied to the water conduit 4. The permeated water that is of the raw water supplied from the water conduit 4 into the vessel 1 through the holes 4a and that permeates the hollow fiber membranes 2 is taken out from the treated water outlet 5, as the treated water, and is stored in the treated water tank 9 through the treated water removing pipe L3.

The concentrated water that does not permeate the hollow fiber membranes 2 is drained from the concentrated water outlet 8 through the pipe L5. The drained concentrated water may be circulated so as to be mixed in the raw water and be supplied to the vessel 1.

The hollow fiber membrane filtration device shown in FIG. 1 performs the filtration treatment by an external pressure method involving passing the raw water to the outside of the hollow fiber membranes 2 in a cross-flow technique in this manner.

When the filtration treatment is continuously performed, the suspended matter accumulates in the hollow fiber membranes 2. Hence, a wash treatment for removing the suspended matter trapped in the hollow fiber membranes 2 is performed as follows after the filtration treatment is performed for a predetermined time or when the treated water amount has been decreased.

[Wash Treatment]

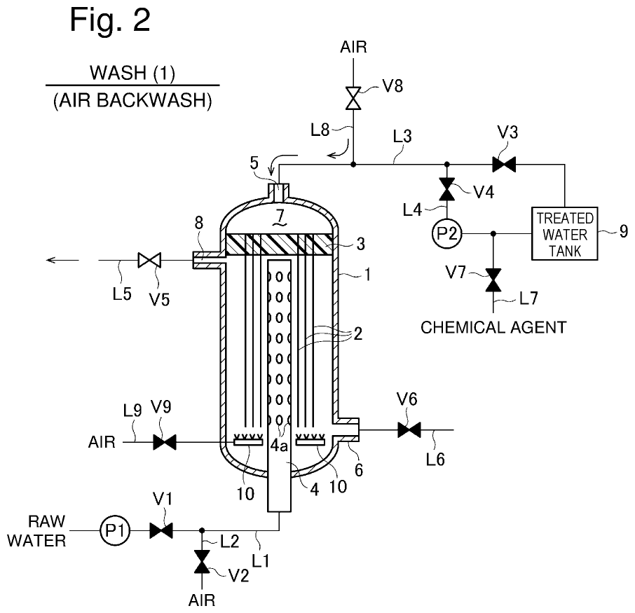

In the wash treatment of the hollow fiber membrane filtration device, first, as shown in FIG. 2, an air backwash is performed. That is, the valves V1, V2, V3, V4, V6, V7, V9 are closed, the valves V5, V8 are opened, and the air is supplied from the treated water chamber 7 into the hollow fiber membranes 2 through the pipe L8, and an air backwash in which the permeated water in the hollow fiber membranes 2 is pushed to the raw water side is performed.

Thereafter, the closing of the valve V8, the opening of the valve V3, and the like are performed, and the interior of the hollow fiber membranes 2 and the interior of the treated water chamber 7 are open to the atmosphere, so that the pressures are released.

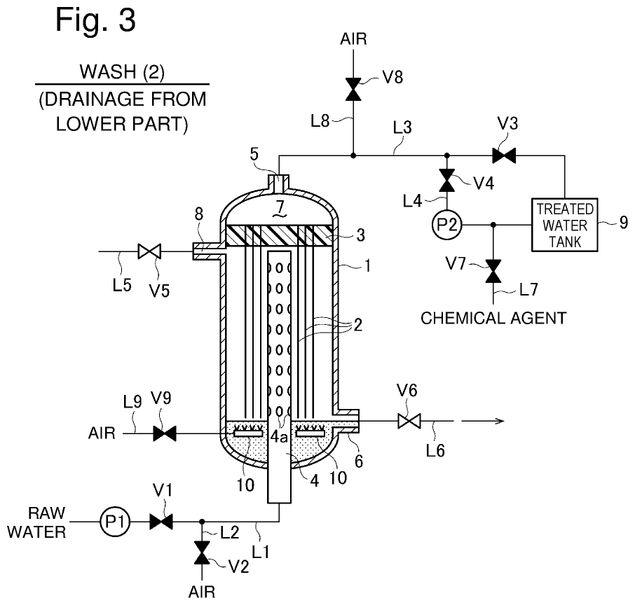

Next, as shown in FIG. 3, the valves V5, V6 are opened, and the water in the vessel 1 is drained through the pipe L6.

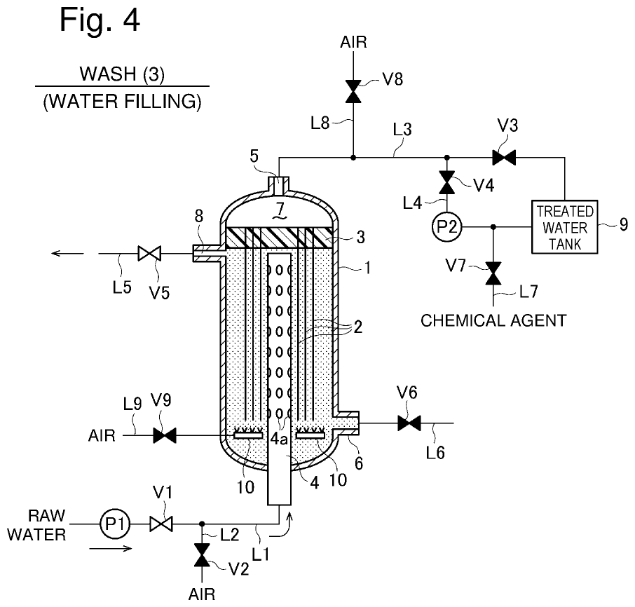

Next, as shown in FIG. 4, the valve V6 is closed, the valves V1, V5 are opened, and the raw water is supplied into the vessel 1 through the pipe L1, the water conduit 4 and the holes 4a, so that the vessel 1 is filled with the water.

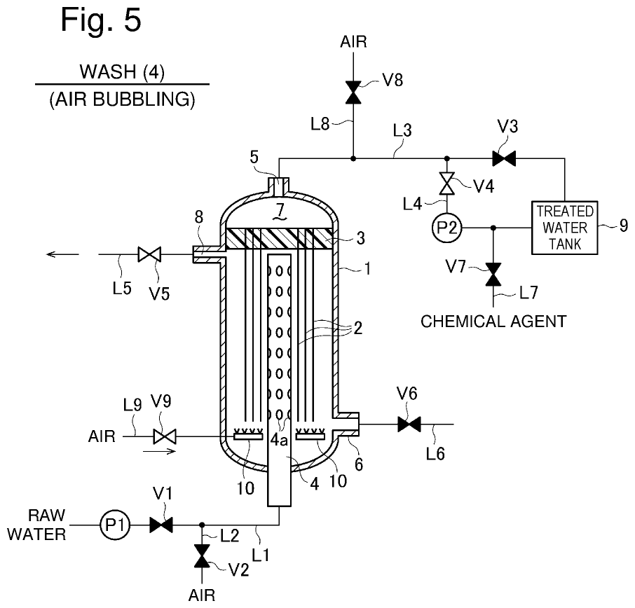

Next, as shown in FIG. 5, the valve V1 is closed, the valves V5, V9 are opened, the air is injected from the diffusion tube 10 into the vessel 1, and a diffusion tube bubbling is performed. The wash drainage water is drained from the concentrated water outlet 8 to the exterior of the system through the pipe L5.

In this case, as shown in FIG. 5, the bubbling wash and the backwash may be performed at the same time. That is, the bubbling may be performed by closing the valve V1, V2, V3, V6, V8, opening the valves V9, V4, V5 and injecting the air from the diffusion tube 10 to the vessel 1, and therewith, the backwash may be performed by actuating the pump P2 and feeding the filtered water into the hollow fiber membranes 2 through the treated water chamber 7. On this occasion, a chemical may be added to the backwash water, by opening the valve V7. Further, the chemical may be added by providing a check valve instead of the valve V7 and activating a chemical feed pump (not illustrated). Furthermore, the water resulting from treating the filtered water with a reverse osmosis membrane may be fed instead of the filtered water, and in that case, a valve, a pipe and the like are provided such that the chemical is added to the water after the treatment.

At the time of the bubbling wash treatment, the wash drainage water may be drained from the drainage port 6 by closing the valve V5 and opening the valve V6, although the illustration is omitted. Further, backwash drainage water may be drained from the drainage port 6 by opening the valve V6 and closing the valve V5 after the drainage of the backwash water from the concentrated water outlet 8 is performed for a predetermined time.

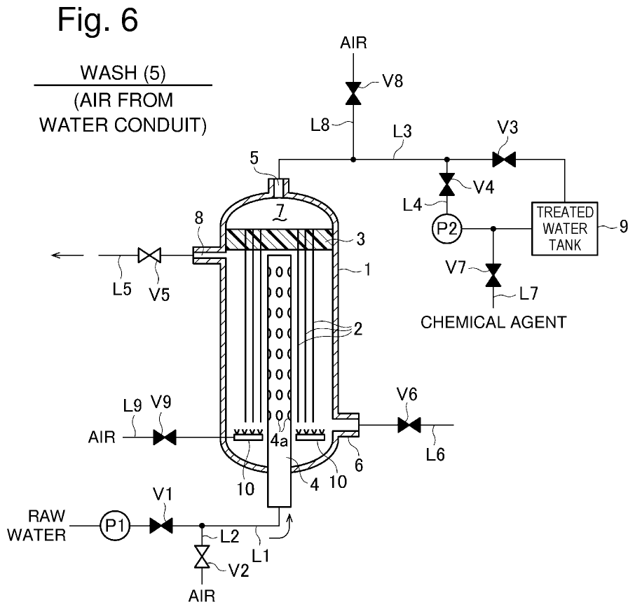

Next, as shown in FIG. 6, after the valve V1 is closed, the valve V2 is opened, the air is supplied from the pipe L2 to the water conduit 4, bubbles are ejected from the ejection holes 4a, and the hollow fiber membranes 2 are washed.

Since many ejection holes 4a are provided on the water conduit 4 over the whole in the vertical direction, it is possible to inject bubbles to the whole of the hollow fiber membranes 2 including the hollow fiber membranes 2 near the upper end fixing member (near the potting member 3), and to remove the suspended matter by the wash evenly and sufficiently. Further, even when the air amount at the time of the bubbling wash is increased, it is possible to prevent kinking and folding of the hollow fiber membranes 2, compared to the method in which the air flows from a lower part of the module to an upper part.

In FIG. 6, only the air is supplied from the pipe L2 into the water conduit 4, but the water and the air may be ejected from the ejection holes 4a by opening the valves V1, V2.

Thereafter, the valves V1, V2 are closed and the valve V6 is opened, so that the water in the vessel 1 is drained from the pipe L6 in the same way as FIG. 4.

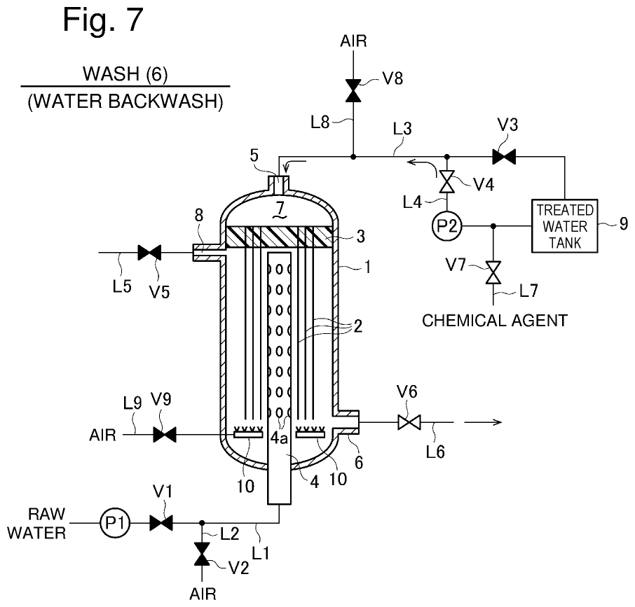

Next, as shown in FIG. 7, the valve V4 is opened, the pump P2 is actuated, the treated water (filtered water) in the treated water tank 9 is supplied into the hollow fiber membranes 2 through the treated water chamber 7, and the water backwash of the hollow fiber membranes 2 is performed. On this occasion, in FIG. 7, the valve V7 is opened, a chemical agent is added to the filtered water from the treated water tank 9, and the backwash of the hollow fiber membranes 2 is performed with the chemical. However, the addition of the chemical agent does not need to be performed. As described above, a configuration of using a check valve and a chemical feed pump may be adopted, and a configuration of feeding the treated water through a reverse osmosis membrane may be adopted.

In FIG. 7, the wash drainage water is drained from the drainage port 6 by opening the valve V6 and closing the valve V5. However, the backwash drainage water may be drained from the concentrated water outlet 8 by closing the valve V6 and opening the valve V5. Although the backwash of the hollow fiber membranes 2 is performed with the filtered water in FIG. 7, the backwash of the hollow fiber membranes 2 may be performed with the raw water. The water backwash may be performed concurrently with the step of supplying the air or the air and raw water to the water conduit shown in FIG. 6.

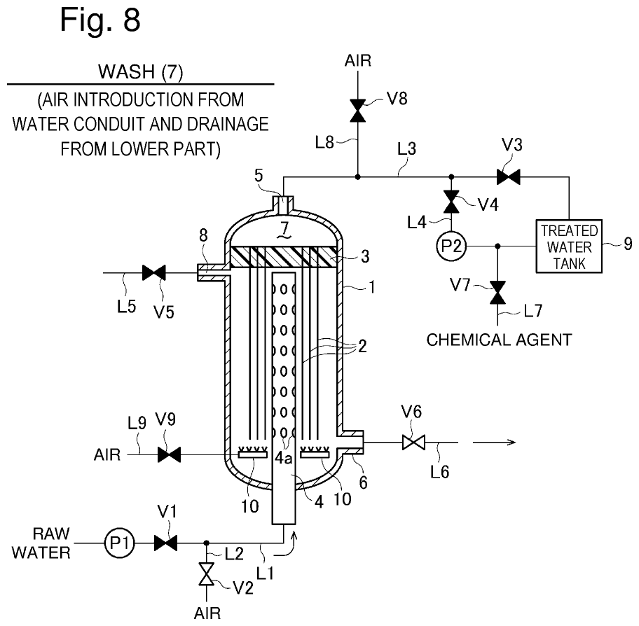

Thereafter, as shown in FIG. 8, the valves V4, V7 are closed, the valves V2, V6 are opened, the air is supplied into the water conduit 4, bubbles are ejected from the ejection holes 4a, the hollow fiber membranes 2 are washed, and the water in the vessel 1 is drained from the pipe L6.

In FIG. 8, only the air is supplied from the pipe L2 into the water conduit 4 by closing the valve V1, but the raw water and the air may be supplied to the water conduit 4 by opening the valves V1, V2.

Thereafter, the valves V2, V6 are closed, the valves V1, V3, V5 are opened, and the vessel 1 is filled with the raw water. Next, the filtration step is restarted as shown in FIG. 1.

In the above description, the supply of the air (or the air and the raw water) to the water conduit 4 and the drainage from the pipe L6 shown in FIG. 8 are performed after the water backwash shown in FIG. 7 is performed. However, the supply of the air (or the air and the raw water) to the water conduit 4 and the drainage from the pipe L6 may be performed when the water backwash in FIG. 7 is being performed. Further, in the middle of the water backwash shown in FIG. 7, the supply of the air (or the air and the raw water) to the water conduit 4 and the drainage from the pipe L6 may be started, while the water backwash is continued.

One of the steps of supplying the air or the air and raw mater to the water conduit shown in FIGS. 6 and 8 can be skipped. Further, in the wash steps shown in FIGS. 6 to 8, instead of performing the steps in order, the water backwash may be concurrently performed in some of the time period when the supply of the air or the air and raw mater to the water conduit is performed, or the supply of the air or the air and raw water to the water conduit may be concurrently performed in some of the time period when the water backwash is performed. In this case, it is preferable to drain the final wash drainage water from the drainage port 6.

In the above description, after the diffusion tube bubbling shown in FIG. 5, the supply of the air (or the air and the raw water) to the water conduit shown in FIG. 6 is performed. Meanwhile, the drainage and water filling shown in FIG. 3 and FIG. 4 may be performed.

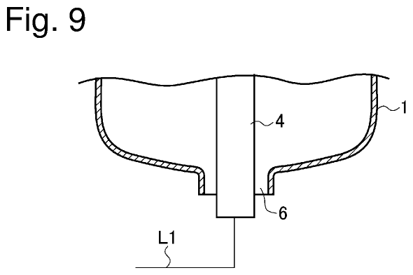

In the above description, the drainage port 6 is provided on the side surface of the lower part of the vessel 1, but the drainage port 6 may be provided at a bottom part of the vessel 1. For example, when the drainage port 6 is formed around the water conduit 4 at a bottom part of the vessel 1 as shown in FIG. 9, the suspended matter is efficiently drained from the vessel, so that the suspended matter removal rate is enhanced.

The above embodiment is an example of the present invention, and the present invention may be configured as an embodiment other than the illustrated embodiment. For example, some wash treatment steps may be skipped. Further, the order of some wash treatment steps may be changed.

### EXAMPLES

### Example 1

A eutrophied A-district industrial water having a turbidity of 6.7 NTU was stored in a raw water tank. The water was fed from the raw water tank to a flocculation tank by a pump, and the residence time was 10 minutes. Before the flocculation tank, 100 mg/L industrial ferric chloride (concentration 38%) was used. After the addition of a flocculation agent, pH was adjusted to 6.2 by hydrochloric acid and sodium hydroxide.

<Filtration Treatment>

The water (referred to as raw water, hereinafter) in the flocculation tank was supplied to the water conduit 4 of the hollow fiber membrane module shown in FIG. 1 through the pump P1 and the raw water pipe L1, and the filtration treatment was performed as shown in FIG. 1. The treatment quantity was 80 L/min×30 min×5 cycles (one cycle: 12 m³).

The configuration of the hollow fiber membrane module is shown as follows.

Vessel 1: inner diameter 200 mm, height 1300 mm

Hollow fiber: inner diameter 0.75 mm, outer diameter 1.25 mm, polyvinylidene fluoride UF membrane with an effective length of 990 mm, membrane area 30 m²

Water conduit 4: length extending in the vessel 1 1000 mm, inner diameter 20 mm, outer diameter 25 mm

Ejection hole 4a: diameter 10 mm, 10 holes.

<Wash Treatment>

As the wash, the following (1) to (4) were performed.

(1) After the filtration treatment, as shown in FIG. 2, the air was supplied from the treated water chamber 7 into the hollow fiber membranes 2 through the pipe L8 at 0.15 MPa for 10 seconds, and the air backwash in which the permeated water in the hollow fiber membranes 2 was pushed to the raw water side was performed. Then, the drainage and the water filling were performed as shown in FIGS. 3 and 4. Thereafter, as shown in FIG. 5, the air was supplied from the diffusion tube 10 at 50 NL/min, and the bubbling wash was performed for 30 seconds.

(2) Next, as shown in FIG. 6, the air was supplied from the water conduit 4 at 50 NL/min for 30 seconds.

(3) Thereafter, the filtered water in the treated water tank 9 was supplied from the pipe L4 to the hollow fiber membranes 2 through the treated water chamber 7, and the water backwash was performed. The water backwash was performed at 80 L/mi for 30 seconds. The backwash drainage water was drained from the concentrated water outlet 8.

(4) Thereafter, the raw water was supplied from the water conduit 4 at 80 L/min for 30 seconds, and was drained from the concentrated water outlet 8 without filtration.

<Measurement of Suspended Matter Removal Rate>

The above filtration treatment and the above wash treatment were alternately performed five times. The drained wash drainage water was taken for each cycle, and the suspended matter amount in the wash drainage water was measured. Table 1 shows the amount (suspended matter removal rate) of the suspended matter drained by the wash to the total amount of the suspended matter supplied during five cycles.

### Example 2

The same treatment as Example 1 was performed except that the filtered water was supplied into the hollow fiber membranes 2 through the pipe L4 and the treated water chamber 7 at 80 L/min and the backwash was performed in the step (2) of feeding the air from the water conduit 4 (that is, the step (4) was performed after the step (2) and the step (3) were performed at the same time). The measurement result of the suspended matter removal rate is shown in Table 1.

### Example 3

The same treatment as Example 1 was performed except that the backwash drainage water was drained from the drainage port 6 in the step (3). The measurement result of the suspended matter removal rate is shown in Table 1.

### Example 4

The same treatment as Example 3 was performed except that the raw water was supplied from the water conduit 4 at 80 L/min together with the air in the step (2). The measurement result of the suspended matter removal rate is shown in Table 1.

### Example 5

The same treatment as Example 3 was performed except that the raw water was supplied from the water conduit 4 at 80 L/min together with the air, the filtered water was supplied into the hollow fiber membranes 2 through the treated water chamber 7 at 80 L/min and the backwash drainage water was drained from the drainage port 6 in the step (2) (that is, the step (4) was performed after the step (2) of supplying the air and the raw water and the step (3) of performing the drainage from the drainage port 6 were performed at the same time). The measurement result of the suspended matter removal rate is shown in Table 1.

### Example 6

The same treatment as Example 5 was performed except that the supply amount of the bubbling air in the step (2) was 150 NL/min. The measurement result of the suspended matter removal rate is shown in Table 1.

### Example 7

The same treatment as Example 6 was performed except that sodium hypochlorite was added to the backwash water (filtered water) such that the concentration was 100 mgCl₂/L in the steps (2) and (3). The measurement result of the suspended matter removal rate is shown in Table 1.

### Comparative Example 1

The same treatment as Example 1 was performed except that a hollow fiber membrane module in which the water conduit 4 was not provided was used and the steps (2) and (4) were skipped. The measurement result of the suspended matter removal rate is shown in Table 1.

### Comparative Example 2

The same treatment as Comparative Example 1 was performed except that the lower end of the hollow fiber membrane was buried and fixed in the potting member. The measurement result of the suspended matter removal rate is shown in Table 1.

TABLE 1

| | Suspended Matter Removal Rate |
|---|---|
| | % |
| Example 1 | 71.1 |
| Example 2 | 73.8 |
| Example 3 | 78.2 |
| Example 4 | 78.6 |
| Example 5 | 79.7 |
| Example 6 | 83.5 |
| Example 7 | 87.3 |
| Comparative Example 1 | 57.4 |
| Comparative Example 2 | 52.1 |

<Consideration>

As shown in Table 1, the following (i) to (viii) were recognized from the above examples and comparative examples.

(i) In Examples 1 to 7, the suspended matter removal rate is higher compared to Comparative Examples 1 and 2 in which the water conduit 4 is not provided.

(ii) In Example 3 in which the wash drainage water is drained from the drainage port 6 at the lower part of the vessel 1 in the step (3), the suspended matter removal performance is higher than in Examples 1 and 2 in each of which the wash drainage water is drained from the concentrated water outlet 8 at the upper part of the vessel 1.

(iii) In Example 4 in which the hollow fiber membranes 2 were further washed with the raw water in the step (2) of feeding the air from the water conduit 4, the suspended matter removal performance is higher than in Example 3.

(vi) In Example 5 in which the backwash of the hollow fiber membranes 2 is further performed with the raw water in the step (2) of feeding the air and the raw water from the water conduit 4, the suspended matter removal performance is higher than in Example 4.

(v) In Example 2 in which the backwash of the hollow fiber membranes 2 is further performed with the filtered water in the step (3) of feeding the air from the water conduit 4, the suspended matter removal performance is higher than in Example 1.

(vi) In Example 6 in which the supply amount of the bubbling air is increased to three times the supply amount in Example 5, the suspended matter removal performance is enhanced compared to Example 5.

(vii) As shown by Example 7, the suspended matter removal performance is enhanced, by adding sodium hypochlorite to the backwash water.

(viii) Comparative Example 1 in which only the upper end of the hollow fiber membrane was fixed exhibits a higher suspended matter removal performance than Comparative Example 2 in which both of the upper and lower ends of the hollow fiber membrane were fixed.

The present invention has been described in detail, using the particular aspects. It is obvious to those in the art that various modifications can be made without departing from the intention and scope of the present invention.

The present application is based on Japanese Patent Application No. 2017-065529 filed on Mar. 29, 2017, which is incorporated by reference in its entirety.

### REFERENCE SIGNS LIST

1 Vessel
2 Hollow fiber membrane
3 Potting member
4 Water conduit
5 Treated water outlet
6 Drainage port
7 Treated water chamber
8 Concentrated water outlet
9 Treated water tank
10 Diffusion tube

1. A method for washing a hollow fiber membrane module, the hollow fiber membrane module comprising:
a vessel that comprises a treated water outlet and a concentrated water outlet;
a water conduit through which raw water is supplied into the vessel;
a plurality of hollow fiber membranes each of which separates the raw water into permeated water and concentrated water, each of the hollow fiber membranes being vertically disposed in the vessel;
an upper end fixing member that fixes upper end parts of the hollow fiber membranes, the upper end fixing member being disposed at an upper part in the vessel;
a treated water chamber that is formed on an upper side of the upper end fixing member, the treated water chamber communicating with an interior of each of the hollow fiber membranes; and
a diffusion member that is disposed on a lower side of the hollow fiber membranes, wherein
the water conduit vertically extends on a lower side of the upper end fixing member, and a plurality of ejection holes are provided on a side peripheral surface, each of the ejection holes being a hole through which the raw water is ejected, and
a drainage port is provided at a lower part of the vessel, the drainage port being a drainage port through which wash drainage water is drained, wherein
the method for washing the hollow fiber membrane module, comprises performing
a bubbling wash in which gas is injected from the diffusion member, and
a water backwash in which backwash water is supplied from the treated water outlet into the hollow fiber membranes.

2. The method for washing the hollow fiber membrane module according to claim 1, wherein the water backwash is performed at a time after or at the same time when air or the air and the raw water are supplied from the water conduit.

3. The method for washing the hollow fiber membrane module according to claim 2, wherein drainage from the drainage port is performed at a time after the air or the air and the raw water are supplied from the water conduit or at a time after the water backwash is performed.

4. The method for washing the hollow fiber membrane module according to claim 1, wherein after the bubbling wash, the water backwash is performed at a time after or at the same time when air or the air and the raw water are supplied from the water conduit.

5. The method for washing the hollow fiber membrane module according to claim 1, wherein a chemical is added to the backwash water.

6. The method for washing the hollow fiber membrane module according to claim 1, wherein the hollow fiber membranes are fixed by only the upper end fixing member.

7. The method for washing the hollow fiber membrane module according to claim 1, wherein
the water conduit is provided so as to penetrate a bottom portion of the vessel and extend in the vessel, and
the plurality of ejection holes are provided on the water conduit.

8. A hollow fiber membrane filtration device comprising a hollow fiber membrane module, the hollow fiber membrane module comprising:
a vessel that comprises a treated water outlet and a concentrated water outlet;
a water conduit through which raw water is supplied into the vessel;
a plurality of hollow fiber membranes each of which separates the raw water into permeated water and concentrated water, each of the hollow fiber membranes being vertically disposed in the vessel;
an upper end fixing member that fixes upper end parts of the hollow fiber membranes, the upper end fixing member being disposed at an upper part in the vessel;
a treated water chamber that is formed on an upper side of the upper end fixing member, the treated water chamber communicating with an interior of each of the hollow fiber membranes; and
a diffusion member that is disposed on a lower side of the hollow fiber membranes, wherein
the water conduit vertically extends on a lower side of the upper end fixing member, and a plurality of ejection holes are provided on a side peripheral surface, each of the ejection holes being a hole through which the raw water is ejected,
a drainage port is provided at a lower part of the vessel, the drainage port being a drainage port through which wash drainage water is drained, and
a raw water pipe and gas introduction means are connected with the water conduit.
